(19) United States
(12) Patent Application Publication
(10) Pub. No.: US 2025/0005819 A1
(43) Pub. Date: Jan. 2, 2025

(54) METHOD, APPARATUS, DEVICE AND STORAGE MEDIUM FOR RENDERING IMAGE

(71) Applicant: Beijing Zitiao Network Technology Co., Ltd., Beijing (CN)

(72) Inventor: Liyou Xu, Beijing (CN)

(21) Appl. No.: 18/756,010

(22) Filed: Jun. 27, 2024

(30) Foreign Application Priority Data
Jun. 27, 2023 (CN) 202310768211.9

(51) Int. Cl. G06T 11/20; G06T 7/11; G06T 7/13; G06T 7/50

(52) U.S. Cl. CPC G06T 11/203; G06T 7/11; G06T 7/13; G06T 7/50; G06T 2207/10016; G06T 2207/20021

(57) ABSTRACT

Embodiments of the disclosure provide a method, apparatus, device and storage medium for rendering an image. The method includes: obtaining respective distance field information of a plurality of image areas in an image of a target object, each image area of the plurality of image areas being defined by a plurality of sampling points, and the distance field information of the image area including respective distance field values and distance field changes of the plurality of sampling points relative to the target object; determining a target image area in the plurality of image areas, a boundary of the target object being located at least partially within the target image area; determining a distance field value of a target point in the target image area relative to the target object; and rendering the target image area on a display interface based on the distance field value of the target point.

### CROSS-REFERENCE

This disclosure claims priority to Chinese Patent Application No. 202310768211.9, filed on Jun. 27, 2023 and entitled “METHOD, APPARATUS, DEVICE AND STORAGE MEDIUM FOR RENDERING IMAGE”, which is incorporated herein by reference in its entirety.

### FIELD

Example embodiments of the present disclosure generally relate to the field of computers, and more particularly, to a method, an apparatus, a device and computer-readable storage medium for rendering an image.

### BACKGROUND

Currently, there is an increasing demand for text rendering, for example, displaying text display in videos. The text may have some special parts, for example, fine lines and tips. During the process of rendering text, details of these special parts are likely to be lost, thereby causing poor text rendering effect. Therefore, it a solution is expected to preserve detail information when rendering text and present the text to the user in a clearer and more complete way.

### SUMMARY

In a first aspect of the present disclosure, there is provided a method for rendering an image. The method includes: obtaining respective distance field information of a plurality of image areas in an image of a target object, each image area of the plurality of image areas being defined by a plurality of sampling points, and the distance field information of the image area including respective distance field values and distance field changes of the plurality of sampling points relative to the target object; determining, based on the respective distance field information, a target image area in the plurality of image areas, a boundary of the target object being located at least partially within the target image area; determining, based on the distance field information of the target image area, a distance field value of a target point in the target image area relative to the target object; and rendering the target image area on a display interface based on the distance field value of the target point.

In a second aspect of the present disclosure, there is provided an apparatus for rendering an image. The apparatus includes an information obtaining module configured to obtain respective distance field information of a plurality of image areas in an image of a target object, each image area of the plurality of image areas being defined by a plurality of sampling points, and the distance field information of the image area including respective distance field values and distance field changes of the plurality of sampling points relative to the target object; a first determining module configured to determine, based on the respective distance field information, a target image area in the plurality of image areas, a boundary of the target object being located at least partially within the target image area; a second determining module configured to determine, based on the distance field information of the target image area, a distance field value of a target point in the target image area relative to the target object; and a rendering module configured to draw the target image area on a display interface based on the distance field value of the target point.

In a third aspect of the present disclosure, there is provided an electronic device, the device includes at least one processing unit; and at least one memory coupled to the at least one processing unit and storing an instruction for execution by the at least one processing unit, when being executed by the at least one processing unit, the instruction causes the electronic device to implement a method of the first aspect.

In a fourth aspect of the present disclosure, there is provided a computer readable storage medium, where the computer readable storage medium stores a computer program, and the computer program is executable by a processor to implement a method in the first aspect.

It should be appreciated that the content described in this Summary is not intended to limit critical features or essential features of embodiments of the disclosure, nor is it intended to limit the scope of the disclosure. Other features of the present disclosure will become readily appreciated from the following description.

### BRIEF DESCRIPTION OF THE DRAWINGS

The above and other features, advantages, and aspects of various embodiments of the present disclosure will become more apparent with reference to the following detailed description taken in conjunction with the accompanying drawings. In the drawings, the same or similar reference numerals denote the same or similar elements, wherein:

FIG. 1 illustrates a schematic diagram of an example environment in which embodiments of the present disclosure can be implemented;

FIG. 2 shows a schematic diagram of an example shape drawn using a conventional solution;

FIG. 3A illustrates a schematic diagram of a portion of the example shape in a sampling grid, according to some embodiments of the present disclosure;

FIG. 3B illustrates a schematic diagram of a portion of another example shape in a sampling grid, according to some embodiments of the present disclosure;

FIG. 4A illustrates a flowchart of a method for rendering an image, according to some embodiments of the present disclosure;

FIG. 4B illustrates a flowchart of a method for determining a distance field value for a target point, according to some embodiments of the present disclosure;

FIG. 5A illustrates a schematic diagram of a portion of an example target object in a sample grid, according to some embodiments of the present disclosure;

FIG. 5B illustrates a schematic diagram of a portion of another example target object in a sample grid, according to some embodiments of the present disclosure;

FIG. 5C illustrates a schematic diagram of a portion of yet another example target object in a sample grid, according to some embodiments of the present disclosure;

FIG. 6 illustrates a flowchart of a method for determining a group of target sampling points, according to some embodiments of the present disclosure;

FIG. 7A and FIG. 7B illustrates a schematic diagram of a fused distance field estimation, according to some embodiments of the present disclosure;

FIG. 8 illustrates a schematic diagram of a plurality of lines in a target image area according to some embodiments of the present disclosure

FIG. 9 illustrates a schematic diagram of a drawn example shape, according to some embodiments of the present disclosure;

FIG. 10 illustrates a block diagram of an apparatus for rendering an image, according to some embodiments of the present disclosure;

FIG. 11 illustrates a block diagram of an electronic device in which one or more embodiments of the present disclosure may be implemented.

### DETAILED DESCRIPTION

It will be appreciated that, before using the technical solutions disclosed in the various embodiments of the present disclosure, the user shall be informed of the type, application scope, and application scenario of the personal information involved in this disclosure in an appropriate manner and the user's authorization shall be obtained, in accordance with relevant laws and regulations.

For example, in response to receiving an active request from a user, a prompt message is sent to the user to explicitly prompt the user that the operation requested to be performed will require acquiring and using personal information of the user. Thus, the user can autonomously select whether to provide personal information to software or hardware such as electronic devices, applications, servers, or storage media that perform operations of the disclosed technical solution, based on the prompt message.

As an optional but non-limiting implementation, in response to receiving an active request from the user, prompt information is sent to the user, for example, in the form of a pop-up window, and the pop-up window may present the prompt information in the form of text. In addition, the pop-up window may also carry a selection control for the user to select whether he/she “agrees” or “disagrees” to provide personal information to the electronic device.

It can be understood that the above notification and user authorization process are only illustrative which do not limit the implementation of this disclosure. Other methods that meet relevant laws and regulations can also be applied to the implementation of this disclosure.

It can be understood that data involved in this technical solution (including but not limited to the data itself, acquisition or use of the data) should comply with the requirements of corresponding laws, regulations and relevant provisions.

Embodiments of the present disclosure will be described in more detail below with reference to the accompanying drawings. Although some embodiments of the present disclosure are shown in the drawings, it should be understood that the present disclosure can be implemented in various forms and should not be construed as limited to the embodiments set forth herein. On the contrary, these embodiments are provided for a more thorough and complete understanding of the present disclosure. It should be understood that the drawings and embodiments of the present disclosure are provided for illustrative purposes only and are not intended to limit the scope of protection of the present disclosure.

It should be noted that the titles of any section/subsection provided herein are not limiting. Various embodiments are described throughout herein, and any type of embodiment can be included under any section/subsection. Furthermore, embodiments described in any section/subsection may be combined in any manner with any other embodiments described in the same section/subsection and/or different sections/subsections.

In the description of the embodiments of the present disclosure, the term “including” and the like should be understood as non-exclusive including, that is, “including but not limited to”. The term “based on” should be understood as “based at least in part on”. The term “one embodiment” or “the embodiment” should be understood as “at least one embodiment”. The term “some embodiments” should be understood as “at least some embodiments”. Other explicit and implicit definitions may also be included below. The terms “first”, “second”, etc. may refer to different or identical objects. Other explicit and implicit definitions may also be included below.

As used herein, the term “sampling point” may correspond to a pixel in an image to be drawn including a target object (also referred to as an image to be drawn). For example, a sampling point may refer to a center point of a corresponding pixel. The term “target point” may refer to a point in the image to be drawn, which may correspond to a pixel in the image to be drawn.

An area defined by a plurality of sampling points may also be referred to as a sampling area or an image area. There may be no other sampling point inside the sampling area. The sampling area may be formed of various shapes such as a triangle, a square, etc. The sampling point may be a vertex of the sampling area. Taking a square sampling area as an example, the sampling points of one sampling area may be four vertexes of the sampling area. The sampling area may also be referred to as a sampling grid, which may be used interchangeably in this disclosure.

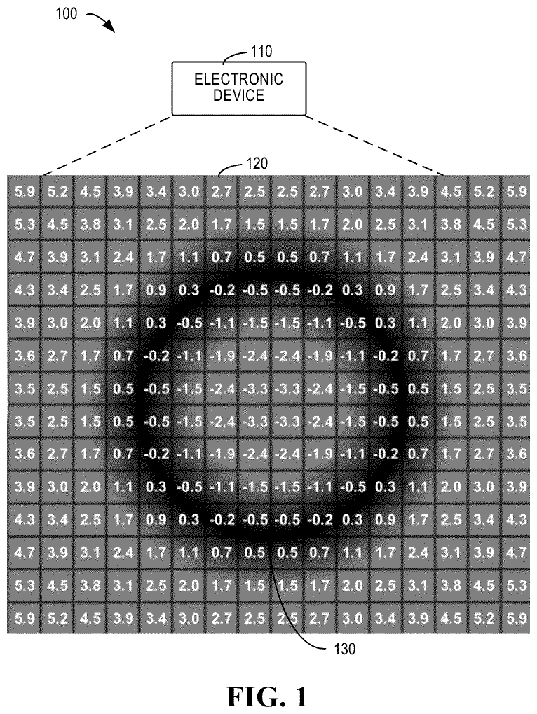

FIG. 1 illustrates a schematic diagram of an example environment 100 in which embodiments of the present disclosure can be implemented. In this example environment 100, an electronic device 110 draws a target object 130 using an image 120 of the target object 130. For example, the electronic device 110 may draw the target object 130 onto a display interface, such as a screen or canvas, and the resolution of the display interface may be greater than the resolution of the image 120.

The electronic device 110 may be any type of device having a computing capability, including a terminal device. The terminal device may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the above, including accessories and peripherals for these devices, or any combination thereof.

In some embodiments, an application may be run on the electronic device 110. For example, the application may be a content sharing application or a content authoring application that is capable of at least providing a user with services related to content consumption, such as content creating, editing, etc. For example, during creating or editing a video, the application may have a requirement of rendering images.

In order to draw the target object 130, the electronic device 110 may use a distance field of the target object 130. The distance field of the target object 130 records a shortest distance value (also referred to as a distance field value) of each of sampling points inside and outside the target object from a contour strip of the target object 130 (also referred to as a boundary). In some embodiments, a directed distance field (also referred to as a signed distance field) of the target object 130 may be utilized. The directed distance field refers to a distance field that identifies the interior and the exterior of the target object 130 by the positive distance field value and the negative distance field value. For example, a distance field value of a sampling point inside the target object 130 may be set to a negative value, and a distance field value of a sampling point outside the target object 130 may be set to a positive value.

In an example of FIG. 1, the image 120 is a distance field image of the target object 130, in particular, a directed distance field image. In other words, a value of each pixel in the image 120 represents a shortest distance of a central point of the pixel (i. e., the sampling point) from the target object 130, and the positive or the negative of the value represents whether the pixel is located inside or outside the target object 130. Such a distance field image may be viewed as a sampling network made up of a plurality of sampling grids. Each of the sampling grids is defined by a plurality of sampling points. For example, a sampling grid may be of a square shape and defined by four sampling points.

For example, the distance field value of a sampling point may be represented as a positive number when the sampling point falls outside the contour of the target object, and the distance field value of a sampling point may be represented as a negative number when the sampling point falls inside the contour. When rendering a target object, a distance field value of each grid point is calculated on a final rendered grid. Then, points having distance field values less than zero may be determined as an internal area of the target object. Alternatively, a predetermined range (for example, a range of 0-d, where d may be set as a threshold) may be determined for the distance field value, and a stroke effect is used when rendering a point having a distance field value within the predetermined range.

Although the target object 130 is shown as a circular in the example of FIG. 1, it should be understood that this is merely exemplary and is not intended to be limiting. In an embodiment of the present disclosure, the target object 130 included in the image 120 may be any element that needs to be drawn, such as an arbitrary shape or a pattern composed of a plurality of shapes. In particular, in some embodiments, the target object 130 may represent text or a portion of text. The target object 130 may also represent other types of elements or portions thereof, such as representing numbers, symbols, patterns, etc.

It should be appreciated that the structure and functionality of the environment 100 are described for exemplary purposes only and are not intended to imply any limitation on the scope of the disclosure. The electronic device 110 can include any suitable structure and functionality for enabling the rendering of a target object. Furthermore, the image of the target object may have any suitable resolution.

Using a shape as an example, as mentioned above, it is sometimes desirable for a resolution of a canvas or screen to which the shape is drawn to be greater than a resolution of an image (e. g., a distance field image) of the shape. In this case, points to be drawn corresponding to some pixels finally on the canvas or screen does not have distance field values. In order to draw the shape, a conventional solution includes determining sampling points of a sampling grid where the points to be drawn are located, and then performing interpolation on the distance field values of these sampling points to obtain distance field values of the points to be drawn. It can be seen that the resolution of the sampling network storing the distance field information has a great influence on the final rendering effect.

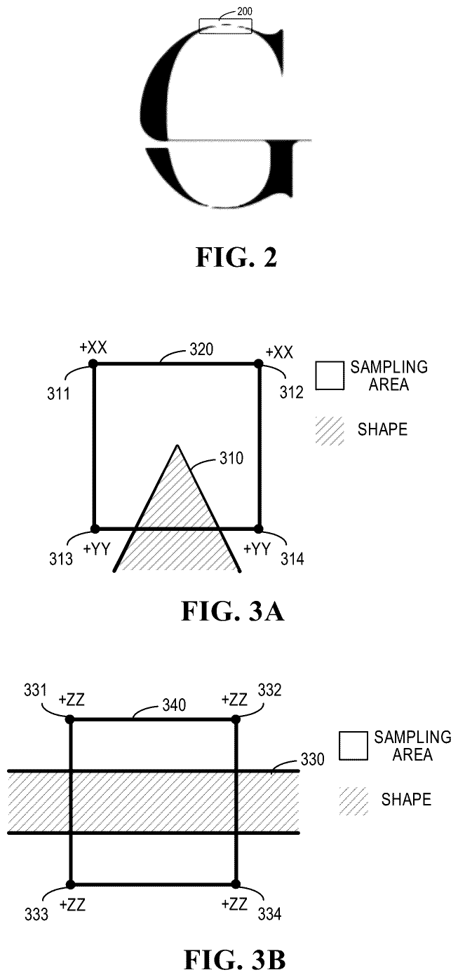

When a shape is drawn using the conventional solution described above, some details (e. g., finer portions) on the shape are lost during rendering. FIG. 2 illustrates a schematic diagram of an example shape drawn using the conventional solution. Taking the shape shown in FIG. 2 as an example, the shape to be drawn in this example represents a letter G. The original shape of the upper edge portion 200 of the shape should be a thinner arc. When the shape is drawn by using a conventional solution, the effect finally presented may be that the upper edge portion 200 of the shape may have a broken line during rendering, such as shown in FIG. 2. The reason why this broken line occurs is that if the upper edge portion 200 falls inside a sampling grid, since the sampling points are all located outside the upper edge portion 200, the distance field values (represented by the shortest distance of each of the sampling points from the upper edge portion 200) of these sampling points are all positive numbers. In this case, the inner area of the arc cannot be determined by means of interpolation, which may lead to loss of information of the upper edge portion 200 (namely, the information of this portion of lines), thereby causing a broken line phenomenon.

For the problem of detail missing that may arise when rendering an image, further analysis thereof will be performed next in conjunction with FIG. 3A and FIG. 3B. FIG. 3A illustrates a schematic of a portion of an example shape in a sampling grid, according to some embodiments of the disclosure. As shown in FIG. 3A, a portion of the shape 310 in the sampling grid 320 is a “sharp corner”. The sampling grid 320 includes sampling points 311, 312, 313, and 314. Since the sharp corners of the shape 310 are located inside the sampling grid 320, the sampling points 311-314 are all located outside the shape 310. In this example, the distance field values of the sampling points 311 and 312 are +XX, indicating that the distance field value is a positive number with a numerical value of XX. The distance field values of the sampling points 313 and 314 are +YY, indicating that the distance field value is a positive number with a numerical value of YY Since the distance field values of the sampling points 311-314 relative to shape 310 are all positive numbers, it results in the interpolations for all points of the shape 320 inside the sharp corners being positive numbers, thereby they will be drawn as an outer area of the shape 310, which results in a loss of the sharp corner of the shape 310 inside the sampling grid 320, when rendering the shape 310.

FIG. 3B illustrates a schematic diagram of a portion of another example shape in a sampling grid, according to some embodiments of the disclosure. As shown in FIG. 3B, a shape 330 is shown as a “stripe” in the sampling grid 340. The sampling grid 340 includes sampling points 331, 332, 333, and 334. Since the strip of the shape 330 is located inside the sampling grid 340, the sampling points 331-334 are all located outside the shape 330. In this example, the distance field values of sampling points 331-334 are +ZZ, indicating that the distance field value is a positive number with a numerical value of ZZ. Since the distance field values of the sampling points 331-334 with respect to the shape 330 are all positive numbers, this will result in the interpolation for all points of the shape 330 in the strip within the sampling grid 340 being positive numbers, thereby they will be drawn as an outer area of the shape 330, which results in a loss of the strip of the shape 330 inside the sampling grid 340, when rendering the shape 330.

The problem of detail loss that may arise when rendering an image has been analyzed above by using shapes as an example. In order to at least partially solve the foregoing problem, embodiments of the present disclosure propose a solution for rendering an image. According to embodiments of the present disclosure, a target object is drawn using distance field values and distance field changes of a plurality of sampling points corresponding to a plurality of image areas in an image of the target object. Specifically, a target image area is determined from a plurality of image areas based on respective distance field information; and based on distance field information of the target image area, a distance field value of a target point in the target image area relative to the target object is determined. Then, a target image area is drawn on the display interface based on the distance field value of the target point. In the embodiment of the present disclosure, the target object is drawn by using the distance field changes, which helps to restore the detail information of the object inside the sampling area, so as to retain the detail information of objects when rendering the target object. In this way, loss of object details can be avoided as much as possible, thereby advantageously improving the visual effect of the drawn object.

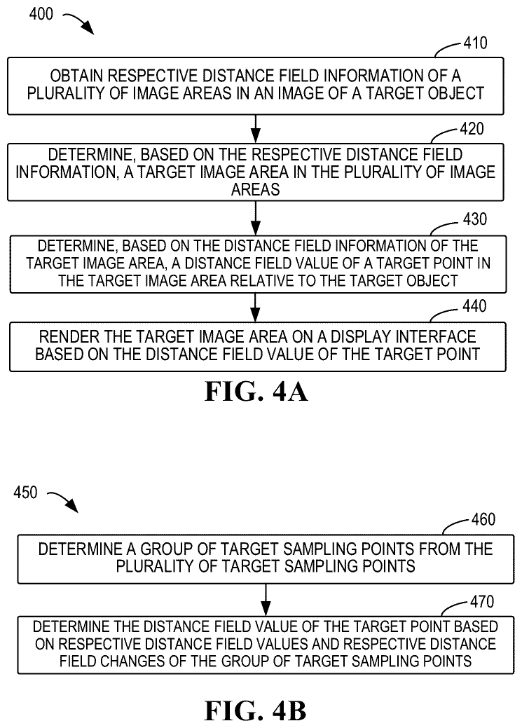

Some example embodiments of the present disclosure are described below with continued reference to the drawings. FIG. 4A illustrates a flowchart of a method for rendering an image according to some embodiments of the present disclosure. In some embodiments, method 400 may be performed, for example, in electronic device 110 shown in FIG. 1.

At block 410, respective distance field information of a plurality of image areas in an image of a target object is obtained, wherein each image area of the plurality of image areas is defined by a plurality of sampling points, and the distance field information of image areas include respective distance field values and distance field changes of the plurality of sampling points relative to the target object. Hereinafter, for convenience of description, an image of the target object is referred to as an image to be drawn or a target image. A target object may be any shape that needs to be drawn or a pattern constituted of such shapes. As an example, a target object may represent text, numbers, symbols, patterns, or other type of elements, etc. Each of the plurality of image areas (i. e., a sampling area or a sampling grid) in an image of the target object may be defined by a plurality of sampling points. There may be no other sampling points inside the sampling area. As an example, the sampling area may be a rectangular grid formed by the center points of four pixels (i. e., four sampling points) in the image 120. The distance field value of each sampling point may indicate the distance of that sampling point from the target object, e. g., the shortest distance from the boundary corresponding to the target. The distance field change of each sampling point may indicate a change of the distance field at that sampling point as compared with the distance field of the target object, for example the distance field change may be a gradient. It should be understood that the gradient may be a representation of the distance field change, and illustration of the gradient in the following is merely exemplary.

The distance field value of each sampling point may be determined in any suitable manner. In some embodiments, a distance field corresponding to each sampling area may be generated for the target object. According to the generated distance field of the target object, each sampling point in each sampling area and a point on the target object closest to each sampling point can be obtained. Thus, the distance value and the gradient of each sampling point can be calculated.

The distance field change (e. g., gradient) is a vector, which may include a gradient direction and a gradient value. In some embodiments, for example, in some distance fields (e. g., directional distance fields), a magnitude of mode length of a gradient value is fixed. In this case, it is not necessary to store the gradient values, and thus only the gradient directions may be stored. Thereby, consumption of storage resources in the process of rendering an image can be saved.

A storage space of a certain number of bits (for example, 8 bits) may be used to store 360 degrees of angle information, so as to represent gradient directions. Taking an 8-bit storage space as an example, a possible angle error may be controlled within 360÷(2⁸)÷2, that is, 0.7 degrees. The gradient value error can be controlled below 0.012. However, conventionally, a method for directly storing gradient values is used, in which a storage space of 1 bit is used for each coordinate axis direction to represent positive and negative signs, and a storage space of 3 bits is used for storing discrete values between 0 and 1. In such a conventional solution, the gradient value error is controlled below 0.125. In this embodiment, by storing the gradient direction, the error may be reduced and the accuracy of the stored gradient information is improved.

At block 420, a target image area is determined from the plurality of image areas based on the respective distance field information of the plurality of image areas in the image of the target object. The boundary of the target object is located at least partially within the target image area. In other words, the target image area has at least part of the boundary of the target object.

In a practical scenario, i not every sampling area or image area includes the boundary of the target object, or for other reasons (e. g., a balance between computational complexity and rendering effect improvement). In view of this, gradient information may be used to process some sampling areas of the image 120, while other sampling areas may be processed in other suitable manners, which is also referred to as a “degradation policy”. Therefore, it is necessary to determine, from a plurality of sampling areas of the image 120, an area for which the gradient information is required to be used, that is, a target image area. An example of determining the target image area will be described below with reference to a “degradation strategy”.

At block 430, a distance field value of a target point in the target image area relative to the target object is determined based on the distance field information of the target image area. As mentioned above, the distance field information includes both distance field values and distance field changes. By utilizing the distance field values and distance field changes, the distance field value of a target point is determined according to any suitable approximation or precision algorithm. An example of how to determine a distance field value based on gradient will be described below with reference to FIG. 4B.

At block 440, the target image area is drawn on the display interface based on the determined distance field value of the target point. For example, the target object may be drawn on a screen. If there are a plurality of target image areas, the rendering process may be performed for each of the target image areas. For other image areas that are not determined to be target image areas, they may be drawn by calculating the distance field values of the drawn points according to any other suitable existing or future developed methods. Thus, the image of the target object may be drawn on the display interface.

Reference is now made to FIG. 4B, which illustrates a flowchart of a method 450 for determining the distance field value of the target point, according to some embodiments of the disclosure. Method 450 may be considered an example implementation of block 430.

At Block 460, a group of target sampling points are determined from the plurality of target sampling points. For a target point in the target image area, a group of target sampling points are determined from the plurality of target sampling points defining the target image area. That is, for each point to be drawn in the target image area, a group of target sampling points to be considered subsequently, also referred to as reference sampling points, are determined.

In order to determine the reference sampling points, these sampling points of the target image area may be grouped, and the sampling points in the same group may be regarded as points for expressing the same line segment of the target object. Taking a square target image area as an example, distance field information corresponding to four sampling points on the target image area may include at most four straight contour lines. In most cases, the line structure contained within the target image area is only composed of two line segments, and the line structure may be, for example, a thin line or a sharp angle; therefore, according to the gradient directions of four sampling points, it can be determined which sampling points among the four sampling points can be divided into one group of target sampling points.

To this end, in some embodiments, if a difference between the respective gradients of two sampling points in the plurality of sampling points of the target image area is less than a threshold difference, it may be considered that the two sampling points express a same line, that is, the two sampling points may be divided into a same group of target sampling points. The specific value of the threshold difference is related to the form of the distance field and the shape of the target image area. Without considering the gradient value, the gradient difference between two sampling points is a difference in gradient direction, and correspondingly, the threshold difference may be a threshold angle. For example, for a square target image area, if an angle difference in gradient direction between two sampling points is smaller than 45 degrees, the two sampling points may be divided into the same group of target sampling points. In this way, it may be determined how many line segments there are inside this target image area, and the plurality of sampling points are grouped, i. e. it is determined which sampling points are a group of target sampling points.

In some embodiments, the interior of the target image area may include only one boundary line of the target object. In this case, all the sampling points in the target image area express the same line. These sampling points are determined as the reference sampling points for the target point. That is, when the distance field value of the target point is subsequently determined, the distance information of all the sampling points may be used.

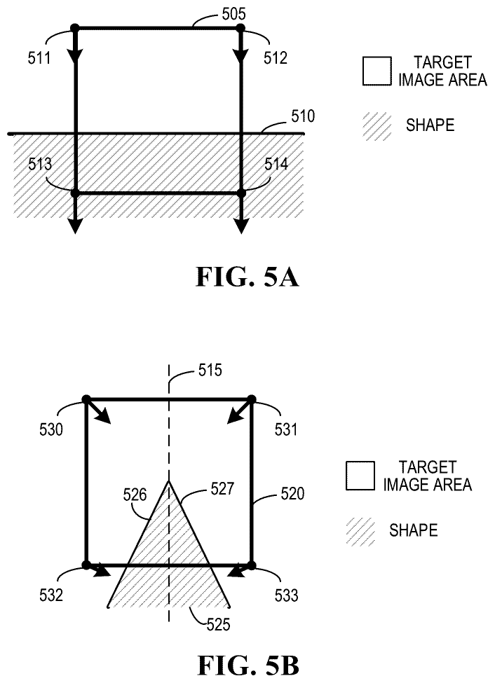

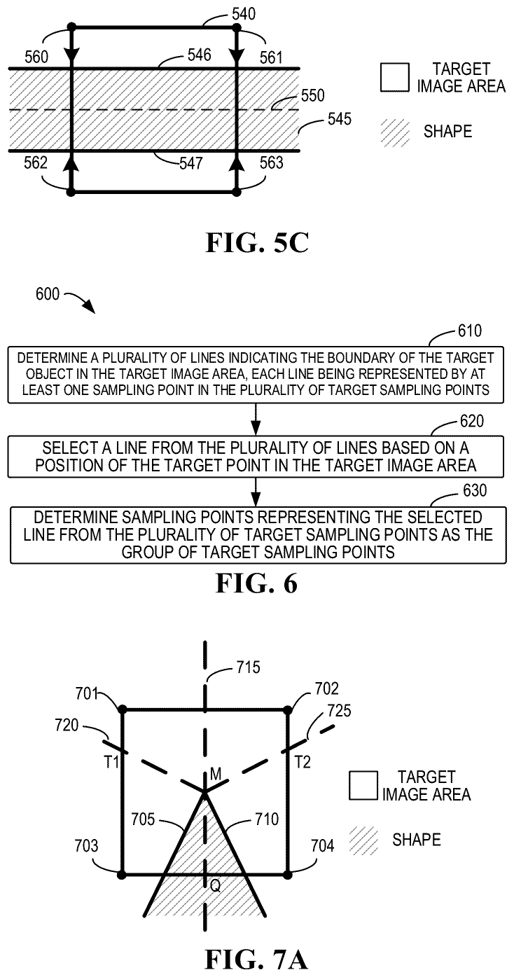

An example is described with reference to FIG. 5A. FIG. 5A illustrates a schematic diagram of a portion of an example target object in a sample grid, according to some embodiments of the disclosure. As shown in FIG. 5A, the shape 510 occupies a lower half of the target image area 505. The target image area 505 includes sampling points 511, 512, 513, and 514. The arrows at respective sampling points in FIG. 5A represent the gradient direction of the corresponding sampling points. As indicated by the arrows, the gradient directions of the sampling points 511, 512, 513 and 514 are all vertically downward (note that the sampling points 513 and 514 are inside the shape, the directed distance field value thereof is negative, and thus the gradient direction is vertically downward). An angle difference in gradient direction between these sampling points is 0 degrees, which is smaller than a threshold difference. Therefore, it can be determined that the sampling points 511, 512, 513, and 514 are the same group of target sampling points, which indicate a boundary of the shape 510 in the target image area 505. In this example, for any target point in the target image area 505, all of the reference sampling points determined at block 420 are those sampling points included in the target image area 505.

In some embodiments, the target image area may include a plurality of boundary lines of the target object. How to determine the reference sampling points in such embodiments is described below with reference to FIG. 6. FIG. 6 illustrates a flowchart of a method 600 for determining a group of target sampling points according to some embodiments of the present disclosure. The method 600 may be viewed as an example implementation of block 460.

At block 610, a plurality of lines indicating the boundary of a target object in a target image area are determined, each line being represented by at least one sampling point in the plurality of target sampling points. In view of the diversity of the target objects, the boundary of the target object in the target image area may not be a straight line. On the other hand, in view of the size of the target image area, in an actual scenario, the boundary is usually an arc with a relatively small curvature. In view of this, the boundary of the target object in the target image area may be approximated by representing lines using sampling points.

In some embodiments, the lines indicating the boundary may be calculated and stored in advance. During the rendering of the target object, they may be read from memory (e. g., cache). Alternatively, the lines may be calculated and stored when the target object is first drawn (e. g., the first frame of the video).

In some embodiments, the lines indicating the boundary may be determined in a manner of grouping the sampling points. For example, the plurality of sampling points may be grouped based on the respective gradients of the plurality of sampling points, so as to obtain a plurality of groups of sampling points, and the difference between respective distance field changes of sampling points in the same group is less than a threshold difference. As mentioned above, the gradient difference between two sampling points is a difference in gradient direction without considering a gradient value, and accordingly, the threshold difference may be a threshold angle. For example, for a square target image area, the threshold angle may be 45 degrees. In such embodiments, for each group of the plurality of groups of sampling points, a line represented by the group of sampling points and indicating the boundary may then be determined as one of the plurality of lines.

An example is described with reference to FIG. 5B. FIG. 5B illustrates a schematic diagram of a portion of another example target object in a sample grid, according to some embodiments of the disclosure. In this example, as shown in FIG. 5B, the shape 525 is presented in the target image area 520 as a sharp corner including two lines. The target image area 520 includes sampling points 530, 531, 532, and 533. An arrow at each of the sampling points in FIG. 5B indicates a gradient direction of the corresponding sampling point. As shown by the arrow, an angle difference between the gradient directions of the sampling points 530 and 532 is smaller than a threshold difference (45 degrees in this example), so it may be determined that the sampling points 530 and 532 are one group of sampling points of the plurality of groups of sampling points. An angle difference between the gradient directions of the sampling points 531 and 533 is also smaller than a threshold difference, and thus it can be determined that the sampling points 531 and 533 are another group of sampling points in the plurality groups of sampling points. In this example, two groups of sampling points may be obtained after grouping the four sampling points according to their respective gradient directions. The sampling points 530 and 532 are the same group of target sampling points and are used to represent the boundary line 526 in the shape 525 located at the left of the line 515. The sampling points 531 and 533 are the same group of target sampling points and are used to represent the boundary line 527 in the shape 525 located at the right of line 515.

Another example is described with reference to FIG. 5C. In this example, as shown in FIG. 5C, the shape 545 is presented in the target image area 540 as a strip including an upper boundary line 546 and a lower boundary line 547. The target image area 540 includes sampling points 560, 561, 562, and 563. An arrow at each of the sampling points in FIG. 5C indicates a gradient direction of a corresponding sampling point. As shown by the arrow, an angle difference between the gradient directions of the sampling points 560 and 561 is smaller than a threshold difference (45 degrees in this example), so it can be determined that the sampling points 560 and 561 are one group of the plurality of groups of sampling points. An angle difference between the gradient directions of the sampling points 562 and 563 is also smaller than the threshold difference, and thus it can be determined that the sampling points 562 and 563 are another group of the plurality of groups of sampling points. In this example, two groups of sampling points can be obtained after grouping the four sampling points according to the respective gradient directions of the sampling points 560-563. The sampling points 560 and 561 are the same group of target sampling points and are used to represent the upper boundary line 546 in the shape 545, and the sampling points 562 and 563 are the same group of target sampling points and are used to represent the lower boundary line 547 in the shape 545.

In such embodiments, sampling points corresponding to the same boundary may be found based on the gradients of the sampling points and then may be used to represent the boundary.

With continued reference to FIG. 6, at block 620, a line is selected from the plurality of lines based on a position of the target point in the target image area. In some embodiments, the distances between the target point and each line of the plurality of lines may be calculated, and then the line closest to the target point may be selected from the plurality of lines.

In rendering the target object, if for each target point, it is necessary to calculate the line closest to the target point, the amount of calculation will be increased. In view of this, in some embodiments, a line may be selected from a plurality of lines according to subareas in a target image area. For example, a plurality of subareas in the target image area may be determined, each subarea including one of the plurality of lines. Then, a subarea in which the target point is located may be determined from the plurality of subareas based on the location of the target point in the target image area. For the target point, a line located in the determined subarea may be selected from the plurality of lines.

Depending on the specific pattern of the target object in the target image area, there may be different ways of dividing the subareas. In some embodiments, the plurality of lines may include a first straight line segment and a second straight line segment that intersect in the target image area. The target image area may be divided into a plurality of subareas through a reference line. Specifically, a reference line bisecting the angle between the first straight line segment and the second straight line segment may be determined. Based on the reference line, the target image area may be divided into a first subarea including the first straight line segment and a second subarea including the second straight line segment.

With continued reference to FIG. 5B, in this example, a first straight line segment may be used to indicate (e. g., approximate) the boundary line 526 and a second straight line segment may be used to indicate the boundary line 527. In the example of FIG. 5B, an angle bisector 515 of an angle formed by the shape 525 in target image area 520 may be used as a reference line. Thus, it can be determined that the target image area 520 includes two subareas, a subarea in the target image area 520 that is located at the left of the angle bisector 515 and a subarea in the target image area 520 that is located at the right of the angle bisector 515. Then, through the position of the target point, which subarea the target point is located in can be determined, so that a line for the target point can be selected. For example, the boundary line 526 may be selected for a target point in the left subarea, and the boundary line 527 may be selected for a target point in the right subarea.

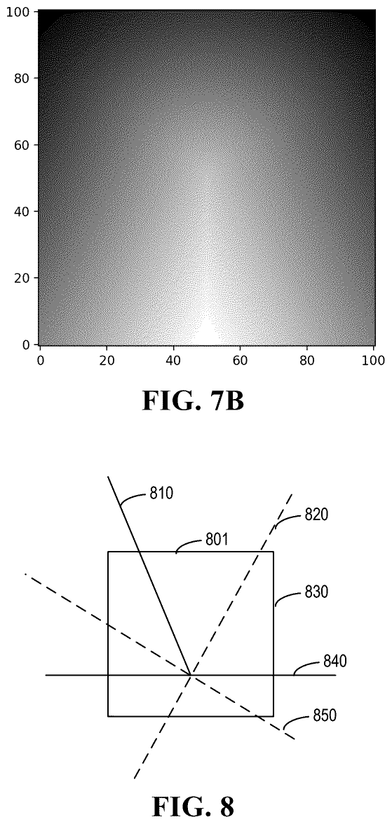

This is illustrated below with reference to FIG. 7A and FIG. 7B. FIG. 7A and FIG. 7B illustrate schematic diagrams of fused distance field estimation according to some embodiments of the present disclosure. In a case that two lines are included in the target image area, it is necessary to perform straight-line approximation estimation on an arc using more than one sampling point, and perform equal-weight fusion on a plurality of straight lines defined by sampling points that belong to the arc, so as to obtain an average straight line.

As shown in FIG. 7A, a straight line 705 is defined or represented by sampling points 701 and 703, which correspond to left boundary of the shape in the target image area, and a straight line 710 is defined or represented by sampling points 702 and 704, which correspond to right boundary of the shape in the target image area. An angle bisector 715 of the two straight lines is made from an intersection point (denoted by point M) of the straight line 705 and the straight line 710, a perpendicular line 720 and a perpendicular line 725 are made for each of the two straight lines, an intersection point of the perpendicular line 720 with the target image area is denoted by a point T1, an intersection point of the perpendicular line 725 with the target image area is denoted by a point T2, and an intersection point of the angle bisector 715 with the target image area is denoted by a point Q. The precise distance field made to the shape of FIG. 7A is shown in FIG. 7B. For a target point located within the angle QMT1, a distance field estimation of the straight line 705 may be used (i. e., line 705 is selected). For a target point located within the angle QMT2, a distance field estimation of the straight line 710 may be used, i. e., the straight line 710 is selected. For a target point located within the angle T1MT2, a distance field estimation of a circular can be used, that is, the distance from the target point to the point M is the distance field value of the point.

With regard to a shape rendering scene, particularly a text rendering scene, as long as a distance field value of a body part of a shape is not affected, the rendering will not be affected by some errors generated by distance value estimation of an outer area. Thus, as described with respect to FIG. 5B, the target image area may be divided into two subareas using an angular bisector, and the target point in each subarea may use the distance field estimation value of a closer straight line segment.

An example of a “sharp corner” condition is described above with reference to FIGS. 5B, 7A, and 7B. Similarly, for the example of FIG. 5C, a center line 550 bisecting the shape 545 can be made in the middle of the upper boundary line 546 and the lower boundary line 547 of the shape 545. Therefore, it can be determined that the target image area 540 includes two subareas: a subarea in the target image area 540 located above the central line 550, and a subarea in the target image area 540 located below the central line 550. Then, which subarea the target point is located in is determined by the position of the target point, so that a line for the target point can be selected. For example, the upper boundary line 546 may be selected for a target point located in the upper subarea. The lower boundary line 547 may be selected for a target point located in the lower subarea.

With continued reference to FIG. 6, at block 630, the sampling points representing the selected line are determined from the plurality of target sampling points as the group of target sampling points. In the example of FIG. 5B, for a target point located in the subarea at the left side of the angle bisector 515, the boundary line 526 represented by the sampling points 530 and 532 is selected, so that these sampling points 530 and 532 are determined as reference sampling points for the target point. For a target point located in the subarea at the right side of the angle bisector 515, the boundary line 527 represented by the sampling points 531 and 533 is selected, so that the sampling points 531 and 533 are determined as reference sampling points for the target point.

In the example of FIG. 5C, for a target point located in the subarea above the center line 550, the upper boundary line 546 represented by the sampling points 560 and 561 is selected, and thus the sampling points 560 and 561 are determined as reference sampling points for the target point. For a target point located in the subarea below the center line 550, the lower boundary line 547 represented by sampling points 562 and 563 is selected, and thus the sampling points 562 and 563 are determined as reference sampling points for the target point.

How reference sampling points are determined for the target point is described above with a plurality of drawings and examples. With continued reference to FIG. 4A, at block 470, the distance field value of the target point is determined based on respective distance field values and respective range field changes of a group of target sampling points (i. e., reference sampling points).

Since arcs are common in a variety of shapes, in a strict sense, the distance field value of a target point may be determined based on a distance of the target point from an arc expressed by the reference sampling points. In some embodiments, a second order Bezier curve formed of distance field values and gradients of the reference sampling points may be determined. For example, if an arc is expressed by i sampling points, the arc may be represented by a second-order Bezier curve formed by distance field values and gradients of these sampling points. The distance field value of the target point may be determined by the distance between the target point and the second-order Bezier curve.

In some embodiments, to further simplify calculations, an approximate mixing strategy using a plurality of straight line distances may be used, e. g., using inverse distance weight (IDW) interpolation. Specifically, the weight of each of the reference sampling points may be determined based on the distance of the reference sampling point from the target point. Then, the distance field value of the target point is determined based on the respective weights, distance field values and gradients of the reference sampling points.

As an example, for a case in which a line in a target image area is an arc, distance field data around the arc may be restored in the approximate mixing manner of a plurality of straight line distances. A distance field of a target point P in a target image area near an arc formed by sampling points V₁, . . . , Vᵢ, . . . (namely, reference sampling points) may be represented as:

$${d}_{p} = \frac{\sum \frac{{d}_{i} + ( \vec{P} - {\vec{V}}_{i} ) \cdot {\vec{g}}_{i}}{\vert \vec{P} - {\vec{V}}_{i} \vert}}{\sum \frac{1}{\vert \vec{P} - {\vec{V}}_{i} \vert}} \qquad ( 1 )$$

wherein dₚ denotes a distance field value of a point P, dᵢ denotes a distance field value of an ith sampling point, \vec{g}ᵢ denotes a gradient of the distance field of the ith sampling point,

$$\frac{1}{\vert \vec{P} - {\vec{V}}_{i} \vert}$$

denotes a reciprocal of a distance of the target point from the sampling point i,

$$\frac{\frac{1}{\vert \vec{P} - {\vec{V}}_{i} \vert}}{\sum \frac{1}{\vert \vec{P} - {\vec{V}}_{i} \vert}}$$

denotes a normalized weight influenced by the estimation of the distance value of the target point P based on the sampling point i, and dᵢ+(\vec{P}−\vec{V}ᵢ)·\vec{g}ᵢ denotes the estimation of the distance field value of the target point P based on the sampling point i.

By determining the distance field value of the target point in this way, the straight line estimation of each of the plurality of sampling points may be converted into a fused arc line estimation. In this way, the distance field estimation can be performed in a simple and efficient way, and a higher accuracy of the distance field estimation can be maintained.

Referring to FIG. 4 above, it is described that the distance field value of the target point is estimated using gradient information of the distance field, thereby a shape is drawn. As mentioned above, a “degradation strategy” may be employed to determine the target image area to be drawn using gradient information. Examples of the degradation strategy are described below.

In some embodiments, if the number of lines indicating the boundary of the target object in the sampling area (as described above with reference to block 610) does not exceed a predetermined number, then gradient information may be used for the sampling area. That is, the sampling area may be determined as the target image area. The predetermined number may be any suitable numerical value, such as 2. That is, if the number of lines of the boundary included in the sampling area exceeds a predetermined number, the gradient information may not be used.

Alternatively, or additionally, in some embodiments, if the distance field values of all of the plurality of sampling points defining a sampling area are smaller than a predetermined value, gradient information may be used for the sampling area. That is, the sampling area may be determined as the target image area. If the distance field value of a certain sampling point is greater than the predetermined value, it means that no boundary of the target object passes through the sampling area. In this case, the gradient information may not be used for the sampling area. The specific size of the predetermined value may depend on the shape of the sampling area and the form of the distance field. For example, in the case of a square sampling area and a directed distance field, the predetermined value may be 1.414. If an absolute value of a distance value of one sampling point in a certain sampling area is larger than 1.414, it indicates that no boundary of the target object passes through the sampling area, and then other image rendering solutions may be considered, for example, a traditional solution.

Alternatively or additionally, in some embodiments, if the reference line bisecting the angle (as described above) is unique, the gradient information may be used for the sampling area. That is, the sampling area may be determined as the target image area. FIG. 8 shows a schematic diagram of a plurality of lines in the sampling area, according to some embodiments of the disclosure. As shown in FIG. 8, in this example, two boundary lines of the target object, i. e., a line 810 and a line 840, are included in the sampling area 801. A bisector is made to the angle between the line 810 and the line 840 in the sampling area to obtain two reference lines, reference line 820 and reference line 850. Since there reference line in this example is not unique, the target point in the sampling area 801 may not be processed using the gradient information.

In such an embodiment, by employing a degradation strategy, it may be ensured that gradient information is applied to appropriate sampling areas to improve the visual effect.

In order to draw a target object using gradient information, such as described with reference to FIG. 4, additional information needs to be determined. In some embodiments, to ensure the rendering efficiency, such information may be predetermined and stored in advance for direct use in rendering. The information that can be predetermined and stored in advance may be information that is independent of the target point P, such as but not limited to respective distance field values and gradients of the plurality of sampling points, information relating to a plurality of lines (e. g., determined at block 610), or information relating to a plurality of subareas (e. g., determined at block 620). In some embodiments, a target object needs to be drawn in a plurality of frames in a video. For example, such information may be determined when the target object is drawn for the first time, and stored during the rendering of the video. For example, such information may be cached, thus, there is no need to repeatedly compute in rendering each frame.

In some embodiments, information related to the above-described degradation strategy may also be determined and stored. For example, the sampling areas for which the gradient information needs to be employed may be determined, and identifiers will be added to these sampling areas. In the rendering process, the method 400 is performed only for sampling areas having the identifiers.

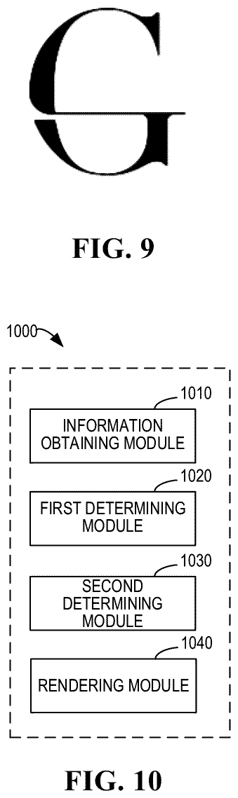

As an example, FIG. 9 illustrates a drawn example shape according to some embodiments of the present disclosure. As compared with FIG. 2, the portions that missed originally can be drawn, thereby improving the visual effect.

FIG. 10 illustrates a schematic block diagram of an apparatus 1000 for rendering an image according to some embodiments of the present disclosure. The apparatus 1000 may be implemented in an electronic device 110. Various modules/components in the apparatus 1000 may be implemented by hardware, software, firmware, or any combination thereof.

As shown in FIG. 10, the apparatus 1000 includes an information obtaining module 1010 configured to obtain respective distance field information of a plurality of image areas in an image of a target object, each image area of the plurality of image areas being defined by a plurality of sampling points, and the distance field information of the image areas including respective distance field values and distance field changes of the plurality of sampling points relative to the target object. The apparatus 1000 further includes a first determining module 1020 configured to determine, based on the respective distance field information, a target image area in the plurality of image areas, a boundary of the target object being located at least partially within the target image area. The apparatus 1000 further includes a second determining module 1030 configured to determine, based on the distance field information of the target image area, a distance field value of a target point in the target image area relative to the target object. The apparatus 1000 further includes a rendering module 1040 configured to draw the target image area on a display interface based on the distance field value of the target point.

In some embodiments, the target image area is defined by a plurality of target sampling points, and the second determining module 1030 is further configured to determine a group of target sampling points from the plurality of target sampling points; and determine the distance field value of the target point based on respective distance field values and respective distance field changes of the group of target sampling points.

In some embodiments, the second determination module 1030 is further configured to determine a plurality of lines indicating the boundary of the target object in the target image area, each line being represented by at least one sampling point in the plurality of target sampling points; select a line from the plurality of lines based on a position of the target point in the target image area; and determine sampling points representing the selected line from the plurality of target sampling points as the group of target sampling points.

In some embodiments, the second determining module 1030 is further configured to group the plurality of target sampling points based on respective distance field changes of the plurality of target sampling points to obtain a plurality of groups of target sampling points, a difference between respective distance field changes of target sampling points in the same group is less than a threshold difference; and for each group of target sampling points of the plurality of groups of target sampling points, determine a line represented by the group of target sampling points and indicating the boundary as one of the plurality of lines.

In some embodiments, the second determining module 1030 is further configured to divide the target image area into a plurality of subareas based on the plurality of lines, each subarea including a line of the plurality of lines; determine from the plurality of subareas a subarea in which the target point is located based on a position of the target point in the target image area; and select a line located in the determined subarea from the plurality of lines.

In some embodiments, the plurality of lines include a first straight line segment and a second straight line segment intersecting each other in the target image area, and a reference line bisecting an angle between the first straight line segment and the second straight line segment is determined; and the target image area is divided into a first sub-area including the first straight line segment and a second sub-area including the second straight line segment based on the reference line.

In some embodiments, the target object is included in a plurality of frames of a video, and at least one of the following is stored in a process of rendering the video: respective distance field values and respective distance field changes of the plurality of target sampling points; information related to the plurality of lines; or information related to the plurality of subareas.

In some embodiments, the second determining module 1030 is further configured to determine respective weights of the group of target sampling points based on respective distances between the group of target sampling points and the target point; and determine the distance field value of the target point based on respective weights, respective distance field values and respective distance field changes of the group of target sampling points.

In some embodiments, the second determining module 1030 is further configured to determine a group of target sampling points from the plurality of sampling points, which includes: in response to differences between respective distance field changes of the plurality of sampling points being less than a threshold difference, determining the plurality of sampling points as the group of target sampling points.

In some embodiments, the second determining module 1030 is further configured to determine, for each image area in the plurality of image areas, the image area as the target image area in response to that the respective distance field values of the plurality of sampling points defining the image area are all less than a predetermined value.

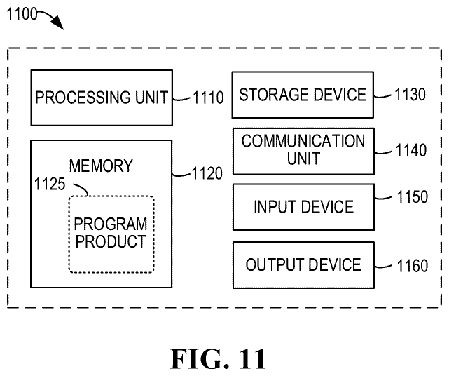

FIG. 11 illustrates a block diagram of an electronic device 1100 in which one or more embodiments of the present disclosure may be implemented. It should be appreciated that the electronic device 1100 shown in FIG. 11 is merely exemplary and should not constitute any limitation on the functionality and scope of the embodiments described herein. The electronic device 1100 illustrated in FIG. 11 may be used to implement the electronic device 110 of FIG. 1.

As shown in FIG. 11, the electronic device 1100 is in the form of a general-purpose electronic device. Components of the electronic device 1100 may include, but are not limited to, one or more processors or processing units 1110, a memory 1120, a storage device 1130, one or more communications units 1140, one or more input devices 1150, and one or more output devices 1160. The processing unit 1110 may be an actual or virtual processor and can perform various processes according to programs stored in the memory 1120. In a multiprocessor system, a plurality of processing units execute computer executable instructions in parallel, so as to improve the parallel processing capability of the electronic device 1100.

The electronic device 1100 typically includes a number of computer storage media. Such media may be any available media that are accessible by electronic device 1100, including, but not limited to, volatile and non-volatile media, removable and non-removable media. The memory 1120 may be a volatile memory (e. g., a register, cache, random access memory (RAM)), non-volatile memory (e.g., read-only memory (ROM), electrically erasable programmable read-only memory (EEPROM), flash memory), or some combination thereof. The storage device 1130 may be a removable or non-removable medium and may include a machine-readable medium such as a flash drive, a magnetic disk, or any other medium that can be used to store information and/or data and that can be accessed within the electronic device 1100.

The electronic device 1100 may further include additional removable/non-removable, volatile/nonvolatile storage media. Although not shown in FIG. 11, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 1120 may include a computer program product 1125 having one or more program modules configured to perform various methods or actions of various embodiments of the present disclosure.

The communication unit 1140 implements communication with other electronic devices through a communication medium. In addition, functions of components of the electronic device 1100 may be implemented by a single computing cluster or a plurality of computing machines, and these computing machines can communicate through a communication connection. Thus, the electronic device 1100 may operate in a networked environment using logical connections to one or more other servers, network personal computers (PCs), or another network node.

The input device 1150 may be one or more input devices such as a mouse, keyboard, trackball, etc. The output device 1160 may be one or more output devices such as a display, speaker, printer, etc. The electronic device 1100 may also communicate with one or more external devices (not shown) such as a storage device, a display device, or the like through the communication unit 1140 as required, and communicate with one or more devices that enable a user to interact with the electronic device 1100, or communicate with any device (e. g., a network card, a modem, or the like) that enables the electronic device 1100 to communicate with one or more other electronic devices. Such communication may be performed via an input/output (I/O) interface (not shown).

According to an exemplary implementation of the present disclosure, a computer readable storage medium is provided, on which a computer-executable instruction is stored, wherein the computer executable instruction is executed by a processor to implement the above-described method. According to an exemplary implementation of the present disclosure, there is also provided a computer program product, which is tangibly stored on a non-transitory computer readable medium and includes computer-executable instructions that are executed by a processor to implement the method described above.

Aspects of the present disclosure are described herein with reference to flowchart and/or block diagrams of methods, apparatus, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

1. A method for rendering an image, comprising:
obtaining respective distance field information of a plurality of image areas in an image of a target object, each image area of the plurality of image areas being defined by a plurality of sampling points, and the distance field information of the image area comprising respective distance field values and respective distance field changes of the plurality of sampling points relative to the target object;
determining, based on the respective distance field information, a target image area in the plurality of image areas, a boundary of the target object being located at least partially within the target image area;
determining, based on the distance field information of the target image area, a distance field value of a target point in the target image area relative to the target object; and
rendering the target image area on a display interface based on the distance field value of the target point.

2. The method of claim 1, wherein the target image area is defined by a plurality of target sampling points, and determining the distance field value of the target point relative to the target object comprises:
determining a group of target sampling points from the plurality of target sampling points; and
determining the distance field value of the target point based on the respective distance field values and the respective distance field changes of the group of target sampling points.

3. The method of claim 2, wherein determining the group of target sampling points from the plurality of target sampling points comprises:
determining a plurality of lines indicating the boundary of the target object in the target image area, each line being represented by at least one sampling point in the plurality of target sampling points;
selecting a line from the plurality of lines based on a position of the target point in the target image area; and
determining, from the plurality of target sampling points, sampling points representing the selected line, as the group of target sampling points.

4. The method of claim 3, wherein determining the plurality of lines comprises:
grouping the plurality of target sampling points based on the respective distance field changes of the plurality of target sampling points to obtain a plurality of groups of target sampling points, a difference between respective distance field changes of target sampling points in the same group being less than a threshold difference; and
for each group of target sampling points in the plurality of groups of target sampling points, determining a line, the line represented by the group of target sampling points and indicating the boundary as one of the plurality of lines.

5. The method of claim 3, wherein selecting a line from the plurality of lines comprises:
dividing the target image area into a plurality of subareas based on the plurality of lines, each subarea comprising a line of the plurality of lines;
determining, from the plurality of subareas, a subarea in which the target point is located, based on the position of the target point in the target image area; and
selecting a line located in the determined subarea from the plurality of lines.

6. The method of claim 5, wherein the plurality of lines include a first straight line segment and a second straight line segment intersecting each other in the target image area, a reference line is determined to bisect an angle between the first straight line segment and the second straight line segment; and
the target image area is divided based on the reference line into a first subarea including the first straight line segment and a second subarea including the second straight line segment.

7. The method of claim 6, wherein the target object is included in a plurality of frames of a video, and at least one of the following is stored in a process of rendering the video:
the respective distance field values and the respective distance field changes of the plurality of target sampling points, information related to the plurality of lines, or information related to the plurality of subareas.

8. The method of claim 2, wherein determining the distance field value of the target point based on the respective distance field values and the respective distance field changes of the group of target sampling points comprises:
determining respective weights of the group of target sampling points based on the respective distances of the group of target sampling points from the target point; and
determining the distance field value of the target point based on respective weights and the respective distance field values and the respective distance field changes of the group of target sampling points.

9. The method of claim 2, wherein determining the group of target sampling points from the plurality of target sampling points comprises:
in response to differences between the respective distance field changes of the plurality of sampling points being less than a threshold difference, determining the plurality of sampling points as the group of target sampling points.

10. The method of claim 1, wherein determining the target image area comprises:
for each image area in the plurality of image areas, in response to the respective distance field values of the plurality of sampling points for defining the image area being all less than a predetermined value, determining the image area as the target image area.

11. An electronic device, comprising:
at least one processing unit; and
at least one memory coupled to the at least one processing unit and storing instructions for execution by the at least one processing unit, the instructions, when executed by the at least one processing unit, causing the electronic device to implement acts comprising:
obtaining respective distance field information of a plurality of image areas in an image of a target object, each image area of the plurality of image areas being defined by a plurality of sampling points, and the distance field information of the image area comprising respective distance field values and respective distance field changes of the plurality of sampling points relative to the target object;
determining, based on the respective distance field information, a target image area in the plurality of image areas, a boundary of the target object being located at least partially within the target image area;
determining, based on the distance field information of the target image area, a distance field value of a target point in the target image area relative to the target object; and
rendering the target image area on a display interface based on the distance field value of the target point.

12. The electronic device of claim 11, wherein the target image area is defined by a plurality of target sampling points, and determining the distance field value of the target point relative to the target object comprises:
determining a group of target sampling points from the plurality of target sampling points; and
determining the distance field value of the target point based on the respective distance field values and the respective distance field changes of the group of target sampling points.

13. The electronic device of claim 12, wherein determining the group of target sampling points from the plurality of target sampling points comprises:
determining a plurality of lines indicating the boundary of the target object in the target image area, each line being represented by at least one sampling point in the plurality of target sampling points;
selecting a line from the plurality of lines based on a position of the target point in the target image area; and
determining, from the plurality of target sampling points, sampling points representing the selected line, as the group of target sampling points.

14. The electronic device of claim 13, wherein determining the plurality of lines comprises:
grouping the plurality of target sampling points based on the respective distance field changes of the plurality of target sampling points to obtain a plurality of groups of target sampling points, a difference between respective distance field changes of target sampling points in the same group being less than a threshold difference; and
for each group of target sampling points in the plurality of groups of target sampling points, determining a line, the line represented by the group of target sampling points and indicating the boundary as one of the plurality of lines.

15. The electronic device of claim 13, wherein selecting a line from the plurality of lines comprises:
dividing the target image area into a plurality of subareas based on the plurality of lines, each subarea comprising a line of the plurality of lines;
determining, from the plurality of subareas, a subarea in which the target point is located, based on the position of the target point in the target image area; and
selecting a line located in the determined subarea from the plurality of lines.

16. The electronic device of claim 15, wherein the plurality of lines include a first straight line segment and a second straight line segment intersecting each other in the target image area, a reference line is determined to bisect an angle between the first straight line segment and the second straight line segment; and
the target image area is divided based on the reference line into a first subarea including the first straight line segment and a second subarea including the second straight line segment.

17. The electronic device of claim 16, wherein the target object is included in a plurality of frames of a video, and at least one of the following is stored in a process of rendering the video:
the respective distance field values and the respective distance field changes of the plurality of target sampling points, information related to the plurality of lines, or information related to the plurality of subareas.

18. The electronic device of claim 12, wherein determining the distance field value of the target point based on the respective distance field values and the respective distance field changes of the group of target sampling points comprises:
determining respective weights of the group of target sampling points based on the respective distances of the group of target sampling points from the target point; and
determining the distance field value of the target point based on respective weights and the respective distance field values and the respective distance field changes of the group of target sampling points.

19. The electronic device of claim 12, wherein determining the group of target sampling points from the plurality of target sampling points comprises:
in response to differences between the respective distance field changes of the plurality of sampling points being less than a threshold difference, determining the plurality of sampling points as the group of target sampling points.

20. A non-transitory computer readable storage medium storing a computer program thereon, wherein the computer program is executable by a processor to implement acts comprising:
obtaining respective distance field information of a plurality of image areas in an image of a target object, each image area of the plurality of image areas being defined by a plurality of sampling points, and the distance field information of the image area comprising respective distance field values and respective distance field changes of the plurality of sampling points relative to the target object;
determining, based on the respective distance field information, a target image area in the plurality of image areas, a boundary of the target object being located at least partially within the target image area;
determining, based on the distance field information of the target image area, a distance field value of a target point in the target image area relative to the target object; and
rendering the target image area on a display interface based on the distance field value of the target point.
